(19) United States
(12) Patent Application Publication
(10) Pub. No.: US 2006/0233322 A1
(43) Pub. Date: Oct. 19, 2006

(54) Methods and apparatus for switching between data streams

(76) Inventors: Mark Allman, Southampton (GB); John Anthony Davies, Winchester (GB); Gerald Reilly, Whitchurch (GB); Andrew Paul Waters, London (GB); Ewan Victor Withers, Bishops Waltham (GB); Brian John Venn, Chandlers Ford (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/371,747

(22) Filed: Mar. 9, 2006

(30) Foreign Application Priority Data
Mar. 24, 2005 (GB) 0506059.5

(51) Int. Cl. H04M 1/64

(52) U.S. Cl. 379/88.01

(57) ABSTRACT

Provided are methods, apparatus and computer program products for switching between data streams. The data streams include a matching set of data items in a consistent sequence. One data stream may be a superset of the other, and which data stream is running ahead of the other may not be known in advance. It is desired to synchronize the data streams so that a data receiver can be switched from a first to a second data stream without loss of data. For a time period of interest, characteristics of a first data item on one stream are compared with characteristics of each latest-received data item on the other stream until a match is identified. This match is used to identify a synchronization point for the switch between data streams.

### FIELD OF THE INVENTION

The present invention relates to communications via a data processing network, and in particular to managing data streams for efficient use of resources.

### BACKGROUND

There is a need to improve the efficiency of resource use in data processing networks. However, because of the complexity of modern data processing systems and networks, and the potential conflicts between requirements such as high performance and assured transactional delivery of messages, optimizing use of resources is a complex task.

In many data processing networks, multiple different data streams may be established between the network nodes. One such network is a publish/subscribe messaging network in which a replay server is associated with a message broker. The replay server allows application programs to receive published messages whenever they require them and not only when they are first published. One of the advantages of this message replay capability is that a subscriber that experiences a connection failure is able to ‘catch-up’ with other subscribers by subscribing to an historical replay data feed. That is, one possible use of message replay capabilities is for a recovering subscriber to start subscribing to a replay data feed, to receive messages published since a defined time in the past, and to continue receiving all messages matching their subscription request. If messages are delivered to the subscriber at a maximum possible rate, the replay subscriber should eventually ‘catch up’ with other subscribers who are subscribing to a new message feed (subject to any inherent latency associated with replay). It may be desirable for the subscriber to simultaneously subscribe to the replay data feed and a feed of new messages, to allow catch up while also receiving new messages as soon as possible.

However, it is undesirable for a large number of subscribers to retain simultaneous subscriptions to a replay feed and a new data feed for a long period of time. Firstly, this involves sending duplicate messages to the same subscribers, which is wasteful of the available network bandwidth and increases the processing workload of the subscribers. Secondly, there will be a need in some environments to check that duplicate messages that contain data update instructions do not jeopardize data integrity at the subscriber.

Furthermore, despite the advantages of replay, resource utilization may not be optimal if historical replay data feeds are used excessively. This is because multiple subscribers to a single shared data feed require less processing by a message broker or message replay server than a number of individual subscribers each having their own dedicated replay feeds. Thus, maintaining multiple dedicated replay feeds can be wasteful even if there is no duplication of messages sent to any individual subscriber.

The inventors of the present invention have identified these problems and determined that there remains a need in the art for improved management of data streams for improved resource use. The inventors have determined that this is especially true in environments in which different subscribers may be subscribing to different data streams when a single shared data stream would make better use of resources, and also in environments in which individual subscribers may simultaneously subscribe to a plurality of data streams that duplicate each other.

US Patent Application Publication No. 2005/0049945 (Bourbonnais et al, published on 3 Mar. 2005) describes log-capture based replication. A mainline log reader publishes messages including transactional data updates to a plurality of queues. When one of the queues becomes unavailable, the mainline log reader continues publishing to the available queues and a catch-up log reader is launched to read from the log and to periodically attempt to publish messages to the unavailable queue. When the unavailable queue becomes available, the catch-up log reader succeeds in publishing to that newly-available queue. When the catch-up log reader reaches the end of the log, the responsibility for publishing messages for that newly-available queue is transferred from the catch-up log reader to the mainline log reader. The catch-up log reader may then be terminated.

Note that US 2005/0049945 relates to managing responsibility for publishing to a particular queue, and does not disclose a solution in which subscribers contribute to the determination of an appropriate time to switch their subscriptions between data feeds. Because of the complete transfer of publication responsibility for a queue, there should be no duplication of messages reaching the queue. Furthermore, in US 2005/0049945, resynchronizing the catch-up log reader with the mainline log reader is relatively simple because responsibility for publishing to the unavailable queue is transferred to the mainline log reader only when the catch-up log reader reaches the end of the log.

### SUMMARY

A first aspect of the present invention provides a method for switching a data receiver from a first data feed to a second data feed, wherein the first data feed includes a set of data items matching a set of data items of the second data feed. The method comprises the steps of: for a time period of interest, comparing characteristics of data items from the second data feed with characteristics of data items from the first data feed to identify matching data items; and, in response to identifying a match, checking that required data items of the first data feed are received by the data receiver and switching the data receiver to the second data feed.

In one embodiment, the invention provides a method for switching a data receiver from a first data feed to a second data feed, wherein the first data feed includes a set of data items matching a consistently sequenced set of data items of the second data feed. The method comprises the steps of: for a time period of interest, comparing characteristics of a first-received data item from the second data feed with characteristics of a most-recently received data item from the first data feed, and repeating the comparison for each received data item from the first data feed; and in response to identifying a match for the first-received data item, checking that required data items of the first data feed are received by the data receiver and switching the data receiver to the second data feed.

In a publish/subscribe environment, the invention can be used to reliably switch a subscriber from a dedicated data feed to a shared data feed, without loss of any required messages. The shared data feed may be, for example, a stream of new messages published via a message broker, or a “near live” data feed published by a replay server. A “near live” data feed in this context is a stream of data sent to subscribers substantially as soon as the data has been stored in the replay server's persistent data store (i.e. almost when received by the replay server, except for system latency).

One of the first and second data feeds may be a superset of the other. The ‘consistently sequenced sets of data items’ comprise identifiable data items arranged in an identical sequence in the two data feeds except that a data feed which is a superset of the other may include additional data items interspersed between the data items that are also found in the subset data feed.

The time period of interest may be a period following a request sent to the subscriber requesting that the subscriber switches from the first to the second data feed. The request may be sent by a server that is the origin of the two data feeds, when the server identifies that the messages currently being sent on a first data feed are also available via the second data feed. If the first feed is a dedicated replay data feed and the second feed is a shared feed, resource use may be optimized by switching the subscriber to the shared feed.

In other embodiments, the time period of interest may be determined with reference to recovery or reconnection of a subscriber, or the time period of interest could be determined with reference to a configurable time period beyond which historical data is considered too old to be of interest for synchronization.

The data items may be messages comprising a message header and data content. In one embodiment of the invention, unique message identifiers are the characteristics used for the comparing step. The message identifiers may be derived from the message headers, for example from a topic name and a topic-scoped sequence number. The message identifiers are compared, and a match between messages in the different streams is used to identify a sufficient degree of synchronization between the data streams to enable switching. In one embodiment, historical context stored for each data stream and used for comparison may comprise a unique identifier for a first received message and a unique identifier for a most-recently received message.

In a publish/subscribe message replay environment, a dedicated historical replay feed will never be running ahead of a new publications data feed nor ahead of a replay server's “near live” feed. This can simplify comparison of the two data feeds to be synchronized, especially if the two feeds contain identical data, since it is then only necessary to perform a one-way comparison to determine whether a first data feed has caught up with a second.

However, in other cases, it is possible to have two data feeds that require synchronization and either of the two data feeds could be running ahead of the other. For example, if a plurality of subscribers have subscribed to receive messages from a shared feed but a lone subscriber has subscribed to a dedicated feed, it may be desired to switch the lone subscriber to the shared feed. In such situations, the above-described step of comparing a first-received data item from the second data feed with a most-recently received data item from the first data feed is still performed, but a second comparison is also performed. This second comparison compares a first-received data item from the first data feed (for the time period of interest) with a most-recently received data item from the second data feed, and repeats the comparison for each newly-received data item. In other words, the data items within both data feeds are tracked to identify sufficient synchronization to enable switching.

A second aspect of the invention provides a method for identifying a synchronization point between first and second data streams, wherein the first data stream includes a set of data items matching a consistently-sequenced set of data items of the second data stream. The method comprises the steps of: for a time period of interest, comparing characteristics of a first data item from the second data stream with characteristics of a most-recent data item from the first data stream; and repeating the comparison for each data item from the first data stream until a match is identified for the first data item.

A further aspect of the invention provides a data processing apparatus comprising a switching controller for switching a data receiver from a first data feed to a second data feed, wherein the first data feed includes a set of data items matching a consistently sequenced set of data items of the second data feed. The switching controller controls the data processing apparatus to perform method steps of: for a time period of interest, comparing characteristics of a first-received data item from the second data feed with characteristics of a most-recently received data item from the first data feed, and repeating the comparison for each received data item from the first data feed; and in response to identifying a match for the first-received data item, checking that required data items of the first data feed are received by the data receiver and then switching the data receiver to the second data feed

The switching controller may be implemented within a subscriber client apparatus of a publish/subscribe messaging network, for controlling switching of the subscriber from a first to a second data feed without loss of required messages. The first data feed may be a dedicated replay feed of a replay server and the second data feed may be a live message feed or a “near-live” replay data feed.

The methods summarized above for certain aspects and embodiments of the invention may be implemented in computer program code. A computer program product according to the invention may comprise a set of program code instructions recorded on a recording medium or available for download via a network, for controlling operations performed by a data processing apparatus.

### BRIEF DESCRIPTION OF DRAWINGS

Embodiments of the invention are described below in more detail, by way of example, with reference to the accompanying drawings in which:

FIG. 1 shows an example network in which embodiments of the present invention may be implemented;

FIG. 2 shows a sequence of method steps performed by a replay server, such as the replay server shown in FIG. 1, according to an embodiment of the invention; and

FIG. 3 shows a sequence of method steps performed by a replay subscriber at a client system, according to an embodiment of the invention.

### DETAILED DESCRIPTION

1. Exemplary Publish/Subscribe Environment

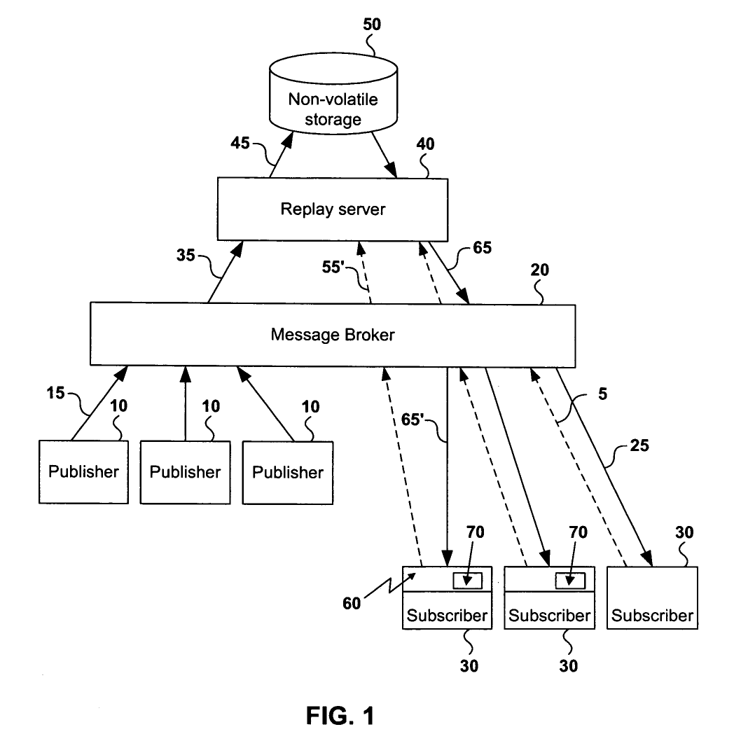

FIG. 1 shows an example publish/subscribe network in which publishers 10 send publications 15 to a message broker 20. In conventional publish/subscribe environments that include a broker, client application subscribers 30 register 5 with the broker 20 and subscribe to receive certain types of messages 25. For example, in topic-based message routing solutions in which each published message contains a topic name within the message header, subscribers may specify the topic names for which they wish to receive published messages. These topic names are character strings describing the nature of the data within the particular published message. The broker 20 compares the topic name of a received message with topics within a stored list of subscriptions, to identify interested subscribers 30, and forwards the message 25 accordingly.

For example, suitable brokers for use in the network of FIG. 1 are the WebSphere Business Integration Message Broker and the WebSphere Business Integration Event Broker software products available from IBM Corporation. WebSphere and IBM are registered trademarks of International Business Machines Corporation.

In general, the publisher and subscriber applications do not need to be aware of each other since the routing of messages (and formatting and optional features such as filtering) is handled by the broker. Despite this decoupling of publishers and subscribers, recent developments have included adding subscriber-awareness to publishers to allow publishers to stop transmitting messages for which there are no subscribers.

Another publish/subscribe model for which the present invention is equally applicable is a content-based routing solution, analyzing the content of messages to identify messages that match subscribers' requirements. Although this contrasts with topic-based routing which typically looks for topic names within headers of published messages, it is known for topic-based routing solutions to include filtering of messages to identify a subset of messages on a particular topic that are of interest to individual subscribers. For example, a subscriber may only be interested in significant events on a particular topic. For simplicity, the following detailed description of embodiments takes the example of topic-based publish/subscribe messaging.

2. Replay Capability

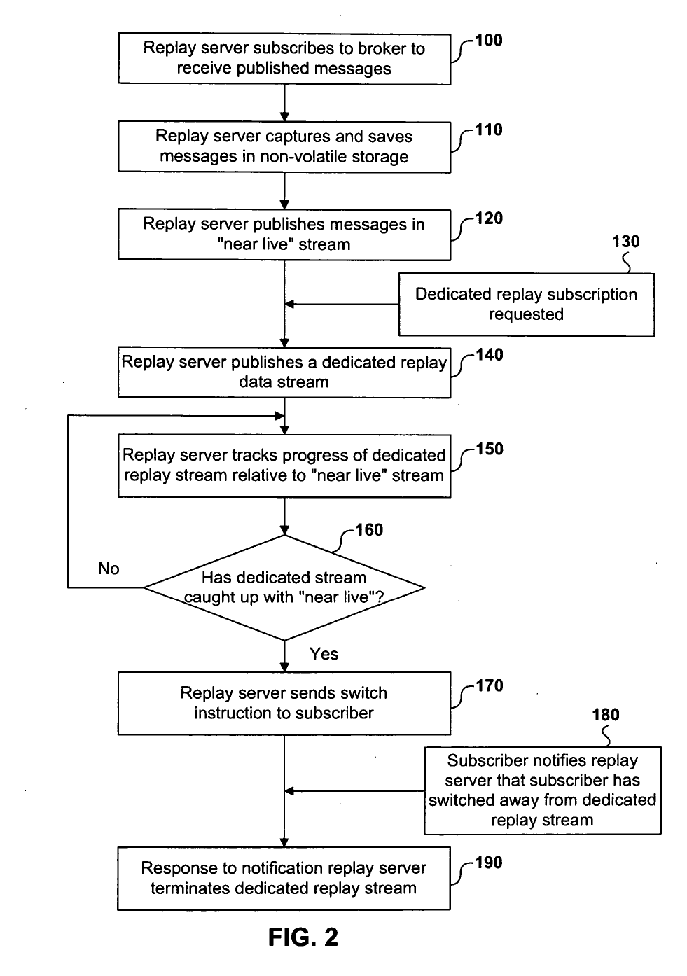

In addition to conventional subscribers 30, the example network of FIG. 1 also includes a replay server 40 that subscribes 100 to a range of topics on the broker. Operations of the replay server are shown in FIG. 2. When a message is published 15 on one of these topics, the message is captured 35 and saved (45, 110) by the replay server in non-volatile storage 50. The non-volatile storage may be provided by IBM Corporation's DB2 database software, or similar database technology. DB2 is a registered trademark of IBM Corporation. Each message has a timestamp and a topic-scoped unique sequence number added to it when the message is saved. The sequence number is a 64-bit integer that is unique for each published message on a specific topic captured by a specific replay server. Each time the message replay server captures a message, the replay server increments the current message sequence number for the topic associated with that message. The timestamp represents the date and time that the message is captured. The timestamps and sequence numbers can be used by a subscriber to specify which messages the subscriber wants to receive, and can be used for synchronizing data streams. The specifying of required messages and the synchronizing of data streams are described in detail below.

The replay server 40 also acts as a type of publisher, publishing 120 stored messages via the broker 20 using reserved topic strings. Certain application programs 30 can register replay-specific-subscriptions 55 with the broker 20 and requirements specified within these replay subscriptions are passed on 55′ to the replay server, so that the applications will receive messages published 65 by the replay server 40 using the reserved topic strings. A significant feature of the message replay capability is the option for subscriber applications to receive replayed messages whenever they require them and not only when published by the original publisher. This is, of course, subject to the qualification that messages will generally not be held in the non-volatile storage of the replay server forever, but the ‘replay when required’ feature is a major difference from conventional publish/subscribe communications.

An application programming interface (API) has been defined to enable Java™ Message Service (JUS) applications to be replay subscribers. That is, replay subscriber applications 60 may be written in the Java™ programming language and implement extensions to the JMS programming interface in order to interoperate with the replay server 40. The JMS applications subscribe (55, 55′,130, 200) to publications that the replay server 40 has stored, by requesting a specific topic or range of topics. As mentioned above, subscribing to a replay data feed enables subscriber applications to receive messages when they require them. In particular, each replay subscriber can request publications on required topics that satisfy one or more of the following criteria:
Publications that have been published since a specific time;
Publications that have sequence numbers in a specified range; and
Publications that have not yet been published.

The requested set of published messages are then sent (65, 65′, 140) to replay subscribers 60 when required. The replay server includes a program-implemented ‘pruning’ capability for removing from the non-volatile storage any messages that are no longer required, but messages are not deleted from the non-volatile store merely because a replay subscriber has received them.

Subscriber applications can initiate (55, 55′, 130, 200) message replay from the replay server 40. Subscribers can specify timestamp values or message sequence numbers to select start and end points for a message replay. This selection can be for messages that have already been captured, or for messages that will be received and captured in future, either up to some specified time or sequence number or indefinitely. Subscribers also specify the topics of interest, as noted above, and can request replay of (for example) every Nth message that satisfies the other criteria for message selection.

The replay server may be used for a number of purposes including sampling, application testing and problem diagnosis. Another example use of the replay server, for which the present invention is particularly useful, is subscriber catch-up. Consider a trading application that uses publish/subscribe messaging to receive stock market data. If the application is not always available, or if the trader who uses the application is not always present, then the application can use message replay to start at a defined time in the past and to receive relevant messages which were published while the application was unavailable or not in use. When the application becomes available again and receives replayed historic messages, the application can also receive new messages as they are captured and routed onwards by the replay server (or, in other embodiments, routed onwards by the broker).

As described below (under section heading C. Switching from dedicated replay feed to shared feed), this can be implemented to allow a temporal overlap between a replay message feed and a new message feed (and may be implemented together with the capability to identify duplicate messages in embodiments in which repeated processing of identical messages could cause loss of data integrity). In one embodiment, a client application simultaneously receives messages from two data feeds and compares the messages on the two data feeds to identify a synchronization point. The client application initiates a switch when a synchronization point is identified.

In an alternative embodiment, the switching between data feeds may be controlled to unsubscribe from one feed and subscribe to the new feed at a consistency point, with no overlaps between the two data streams flowing to the client application.

The ability to replay messages missed while an application was disconnected has similarities to known ‘durable’ subscriptions, in which the broker retains a persistent copy of a subscription and of each relevant publication until the relevant subscriber acknowledges receipt of the publication, or a defined expiry time is reached. However, message replay has another advantage in that it may use a high performance transfer protocol that avoids some of the complexities of other transactional-assured-delivery solutions. That is, message replay may combine persistence with high-performance, low-overhead messaging.

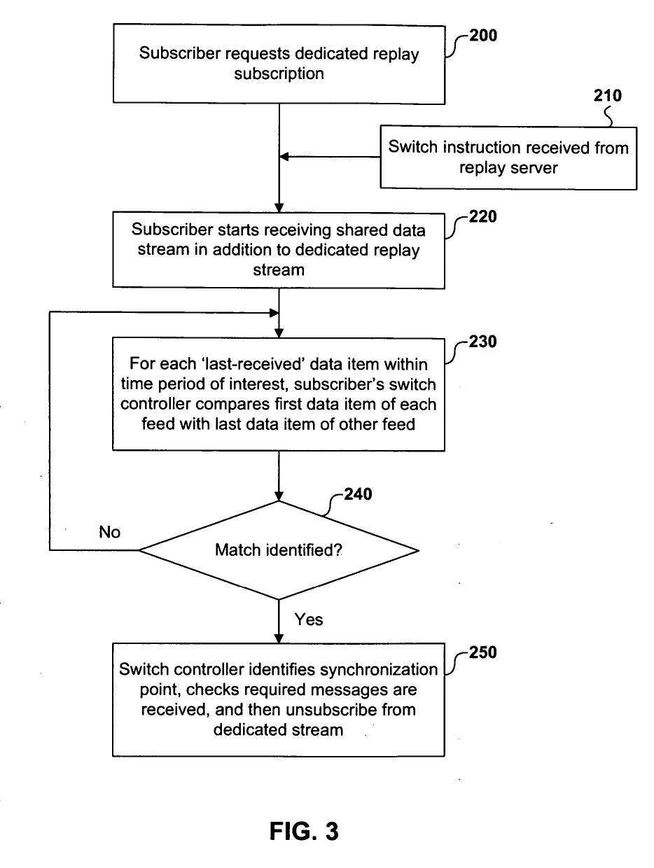

Operations of replay subscribers are described in detail below with reference to FIG. 3. When the replay server is used for catch-up purposes, a replay subscriber may subscribe 200 to a dedicated replay data feed and this may be replayed at maximum rate (if that is specified in the replay subscription) so that the replay subscriber catches up with other subscribers as quickly as possible. At some point in time, it may be desired to switch the replay subscriber from the dedicated replay data feed to a shared feed to optimize resource use. That is, running multiple dedicated replay feeds may make less efficient use of resources and result in poorer performance than if multiple subscribers receive data via a single shared data feed. A solution for switching between data feeds is described below.

C. Switching from Dedicated Replay Feed to Shared Feed

Let us consider the example scenario of a single subscriber to a dedicated replay data feed and a plurality of other subscribers receiving equivalent messages via a shared data feed. As noted above, this is merely exemplary of many scenarios in which it is desirable to switch a subscriber from a first to a second data feed, but the example is likely to be a relatively common scenario if the dedicated replay data feed is used for catch-up purposes.

The shared data feed could itself be a replay data feed, such as a “near live” feed which sends messages to subscribers as soon as the messages are stored in the non-volatile store 50, but this is not essential.

Let us assume that the subscriber to the dedicated replay data feed became a subscriber to the dedicated replay feed when reconnected to the message broker following a disconnected period (for example, following a connection failure). In particular, the subscriber application sends 200 a request to the message broker to subscribe to the dedicated replay feed, specifying the topic of interest (using the relevant reserved topic string for replay) and specifying either a start time or message sequence number corresponding to the last received message before the subscriber disconnected from the broker.

Subscriber applications may be configured to automatically subscribe to a dedicated replay data feed when reconnecting to a message broker following a disconnected period. That is, subscribers may reactivate their earlier subscriptions (from a time just prior to disconnection) and subscribe to a dedicated replay feed on topics corresponding to the topic names of their earlier subscriptions. In other embodiments, in which automated replay subscription is not implemented, the application administrator may be required to specify what subscriptions are required following reconnection.

A switch of a replay subscriber away from the dedicated replay feed may be triggered by a control message 210 from the replay server 40, such as upon the progress of catch-up as determined by the replay server. In particular, the replay server identifies when messages being published on a dedicated replay data feed are also being published on a “near-live” replay data feed. In one embodiment, the replay server tracks the progress of a dedicated replay stream relative to a shared data stream with reference to timestamps and unique message identifiers.

Thus, in a first embodiment of the invention, the replay server detects when a transmitted historical replay data stream has approximately caught up with a transmitted “near-live” data stream, and then sends 210 a control message to the client subscriber application. A switch controller 70 within the client application can then check receipt of messages from the two data streams, as described below.

In alternative embodiments, the switch-initiating control message may be triggered by a client application upon expiry of a defined time period (based on assumptions regarding the likely time required to catch up). In another alternative, the signal that initiates switching may be triggered by the subscriber application user.

The following description refers, for simplicity, to embodiments in which the replay server 40 is tracking the progress of catch-up of transmitted messages and switching is triggered by a control signal 210 from the replay server. If a data stream of new messages is not yet flowing to the subscriber, when the switch-initiating control signal is triggered, a new data stream is opened between the broker 20 and the subscriber application 30, 60. At this stage, the subscriber application is receiving 220 messages from two data streams simultaneously. Although the replay server tracks the progress of transmitted messages, the subscriber application is responsible for tracking the progress of received messages and switching between data streams. Implementing switch control within the subscriber reduces the processing load on the server, and simplifies administration relative to a solution in which the replay server is solely responsible for switching the subscriber between data feeds.

The new data stream may be a superset of the messages transmitted via the dedicated replay data feed, but a more common scenario in message replay solutions is that the dedicated replay data feed and the new data feed include identical sets of messages in the same sequence. Therefore, the main difference between these two feeds is often a lack of synchronization and possibly a different data transfer rate. If synchronization of received messages can be achieved, the subscriber application can unsubscribe 250 from the dedicated replay feed without loss of any messages.

When there are no longer any subscribers to dedicated replay feeds, the replay server can stop publishing its replay data. Nevertheless, data will continue being stored in the non-volatile data repository 50 in readiness for the next disconnection of a subscriber.

There are two scenarios to consider when switching from a current data stream to a new stream. The first scenario is when the current stream is running ahead of the new stream, and the second scenario is the converse (when the current stream is running behind the new stream).

For each data stream, a certain amount of state information is saved by a client subscriber application to find a switch consistency point. The state information saved is:
An identifier of the first-received message after a control message indicates that a switch is required. This identifier does not change and only needs storing once. For an existing data stream, the identifier of the first-received message is obtained when information is received that a switch is required. For a new data stream, the first-received message may be the first message received when the new data stream is started.
An identifier of the last received message. This changes as each new message is received.

Each message identifier is generated from a topic name and sequence number of the message. A switching controller component within the client application tracks (230, 240) the state information for the two data streams. Given that it is unknown which stream is running ahead, two parallel sweeps are run to find a consistency point: The first received message of the new stream is compared 230 with the most-recently received message of the current stream. A match 240 in this sweep determines both a point of consistency and that the current stream is running behind the new stream. The first received message of the current stream is compared 230 with the last received message of the new stream. A match 240 in this sweep determines both a point of consistency and that the current stream is running ahead of the new stream.

These twin sweeps are accomplished as new messages arrive on each stream. The two sweeps can run independently. A match cannot happen in both sweeps simultaneously unless the two streams are already exactly synchronized, because messages are uniquely identifiable.

When a consistency point is found, one of the following two operations 250 is performed: (1) If a first-received message of the current stream matches a most-recent received message of the new stream, the current stream is running ahead. In this case the current stream is stopped and the new stream throws away received messages up to and including the last message received by the (now stopped) current stream. At this point, after duplicate messages have been discarded, the flow to the subscriber is switched to the new stream. (2) If a most-recently received message of the current stream is identified as a match with the first-received message of the new stream, the current stream is running behind. In this case the new stream is buffered and the subscriber remains subscribed to the current stream until it receives the first message in the new stream buffer. At this point, the flow to the subscriber is switched to the new stream. This involves draining the buffer to the subscriber, and then allowing the normal message flow to take over. The current stream is then stopped.

### EXAMPLE 1

### Current Stream Ahead

Current Stream: Messages Received (in order, since switch request): <D, E, G, H, K>; New Stream: Messages Received (in order, since start): <A, B, C, D, E, F, G, H, I, J, K>. This is a superset of the existing stream.

From the Current Stream, D is stored as the first-received message (and this remains unchanged for the time period of interest), and D is also initially saved as the most-recently received message of the current stream. This most-recently received message is then updated (D-->E, E-->F, etc) each time a new message appears.

From the New Stream, A is stored as its first-received message, and the most-recently received message starts at A and is updated each time a new message appears.

A check is performed of each most-recently received message from the Current Stream against the first received message of the New Stream. This will not produce a hit in the current example.

A check is performed of each most-recently received message from the New Stream against the first received message of the Current Stream. This produces a hit when the New Stream receives D. The Current Stream is stopped, the elements of the New Stream are discarded until K is reached (K being the last message delivered to the user), and then delivery of elements to the user continues.

### EXAMPLE 2

### Current Stream Behind

Current Stream: Messages Received (in order, since switch request): <A, B, D, E, G>; New Stream: Messages Received (in order, since start): <D, E, F, G, H, I, J, K, L, M, 0, P>. This is a superset of the existing stream.

From the Current Stream, A is stored as the first received message, and the most-recently received message starts at A and is updated each time a new message appears. From the New Stream, D is stored as the first received message, and the most-recently received message starts at D and is updated each time a new message appears.

A check is performed for each last received message of the Current Stream against the first received message of the New Stream. This produces a hit when the Current Stream receives D. The New Stream is buffered and the Current Stream continues delivering messages to the user until the Current Stream reaches the first message in the New Stream buffer. At this point the Current Stream is stopped, the New Stream buffer is drained to the subscriber and then the New Stream takes over delivering messages to the user.

A check is performed of each most-recently received message of the New Stream against the first received message of the Current Stream. This will not produce a hit.

The above description of exemplary embodiments includes a solution to the problem of how to reliably switch a subscriber from a dedicated replay feed over to a shared data feed without message loss. The subscriber is deregistered from the dedicated replay feed and registered with the shared feed. Historical context information is stored persistently for each of the two data feeds and is compared in order to identify when the two data feeds are sufficiently closely synchronized that switching can occur. The historical information is then used to synchronize the switch from the existing subscription to the new one, by matching messages received in the histories of each stream and ensuring that required messages are received.

The embodiment described above achieves efficient identification of the synchronization point by remembering just two elements: the first message received after the switch was requested, and the last message received. The two message identifiers are then compared to find a point of consistency so the switch can take place. The message data itself is not compared, only the header context required to uniquely identify each message. In the above example, the information used for message identification is a topic and topic-scoped sequence number.

In alternative embodiments of the invention, further state information may be obtained and compared to identify synchronization points, and the uniquely identifiable characteristics of data items to be compared may be something other than topic names and topic-scoped sequence numbers. For example, hash values or other identifiers of the data items may be used.

The above-described embodiment implements switch control logic at the client data processing system, in particular as program code 70 within a subscriber application 60. In alternative embodiments of the invention, the comparison of unique message identifiers to identify synchronization between two data streams can be performed at the replay server.

What is claimed is:

1. A method for switching a data receiver from a first data feed to a second data feed, wherein the first data feed includes a set of data items matching a set of data items of the second data feed, the method comprising the steps of:
for a time period of interest, comparing characteristics of data items from the second data feed with characteristics of data items from the first data feed to identify matching data items; and,
in response to identifying a match, checking that required data items of the first data feed are received by the data receiver and switching the data receiver to the second data feed.

2. The method of claim 1, wherein the first data feed includes a set of data items matching a consistently-sequenced set of data items of the second data feed, and wherein the comparing step comprises comparing characteristics of a first-received data item from the second data feed with characteristics of a most-recently received data item from the first data feed, and repeating the comparison for each received data item from the first data feed.

3. The method of claim 1, wherein the first data feed is a dedicated replay data feed transmitted by a replay server, and the second data feed is a shared data feed shared by a plurality of data receivers.

4. The method of claim 3, wherein the shared data feed comprises data items transmitted by a replay server substantially immediately following the replay server storing said data items in non-volatile storage.

5. The method of claim 1, wherein the data receiver is a subscriber application program within a publish/subscribe communication network.

6. The method of claim 1, wherein the time period of interest is a time period following a request to switch the data receiver from the first to the second data feed.

7. The method of claim 6, wherein the first data feed is a dedicated replay data feed transmitted by a replay server, and the request to switch is triggered in response to determining that the dedicated replay data feed is approximately synchronized with the second data feed.

8. The method of claim 2, further comprising the steps of:
for the time period of interest, comparing characteristics of a first-received data item from the first data feed with characteristics of a most-recently received data item from the second data feed, and repeating the comparison for each received data item from the second data feed; and
in response to identifying a match, checking that required data items are received by the data receiver and switching the data receiver to the second data feed.

9. The method of claim 8, wherein the step of checking that required data items are received by the data receiver comprises:
if a first-received data item of the first data feed matches a most-recently received data item of the second data feed, the first data feed is stopped and duplicate data items within the second data stream up to and including said most-recently received data item are discarded; whereas
if a first-received data item of the second data feed matches a most-recently received data item of the first data feed, the second data stream is buffered and the data receiver continues receiving data items from the first data stream until the data receiver receives the first data item in the second data stream buffer, and then the buffer is drained to the data receiver.

10. The method according to claim 1, wherein the compared characteristics are derived from respective sequence numbers of the data items.

11. The method of claim 10, wherein the data items are messages within a topic-based publish/subscribe messaging network and wherein the compared characteristics are derived from respective sequence numbers and message topics.

12. A data processing apparatus comprising a switching controller for switching a data receiver from a first data feed to a second data feed, wherein the first data feed includes a set of data items matching a set of data items of the second data feed, and wherein the switching controller controls the data processing apparatus to:
for a time period of interest, compare characteristics of data items from the second data feed with characteristics of data items from the first data feed; and,
in response to identifying a match, to check that required data items of the first data feed are received by the data receiver and to switch the data receiver to the second data feed.

13. The data processing apparatus of claim 12, wherein the first data feed includes a set of data items matching a consistently-sequenced set of data items of the second data feed, and wherein comparing comprises comparing characteristics of a first-received data item from the second data feed with characteristics of a most-recently received data item from the first data feed, and repeating the comparison for each received data item from the first data feed; and, in response to identifying a match for said first-received data item, checking that required data items of the first data feed are received by the data receiver and switching the data receiver to the second data feed.

14. A method for identifying a synchronization point between first and second data streams, wherein the first data stream includes a set of data items matching a consistently sequenced set of data items of the second data stream, the method comprising the steps of:
for a time period of interest, comparing characteristics of a first data item from the second data stream with characteristics of a most-recent data item from the first data stream; and
repeating the comparison for each data item from the first data stream until a match is identified for said first data item.

15. The method of claim 14, implemented at a data receiver within a data processing network, for identifying a synchronization point at which to switch the data receiver from the first data stream to the second data stream.

16. The method of claim 14, implemented at a replay server within a publish/subscribe communication network, for identifying a synchronization point between first and second data streams transmitted by the replay server.

17. A computer program product for switching a data receiver from a first data feed to a second data feed, wherein the first data feed includes a set of data items matching a set of data items of the second data feed, said computer program product comprising a computer readable medium having computer readable program code tangibly embedded therein, the computer readable program code comprising:
computer readable program code configured to compare, for a time period of interest, characteristics of data items from the second data feed with characteristics of data items from the first data feed to identify matching data items; and,
computer readable program code configured to check, in response to identifying a match, that required data items of the first data feed are received by the data receiver and to switch the data receiver to the second data feed.

18. The computer program product of claim 17, wherein the first data feed includes a set of data items matching a consistently-sequenced set of data items of the second data feed, and wherein the computer readable program code configured to compare comprises computer readable program code configured to compare characteristics of a first-received data item from the second data feed with characteristics of a most-recently received data item from the first data feed, and to repeat the comparison for each received data item from the first data feed.

19. The computer program product of claim 17, wherein the first data feed is a dedicated replay data feed transmitted by a replay server, and the second data feed is a shared data feed shared by a plurality of data receivers.

20. The computer program product of claim 19, wherein the shared data feed comprises data items transmitted by a replay server substantially immediately following the replay server storing said data items in non-volatile storage.
